(19) United States
(12) Patent Application Publication
(10) Pub. No.: US 2006/0146068 A1
(43) Pub. Date: Jul. 6, 2006

(54) Mobile communication terminal and method therefore

(76) Inventors: Paivi Jokinen, Tampere (FI); Nina Maki, Pirkkala (FI); Sanna M. Koskinen, Tampere (FI)

Correspondence Address: PERMAN & GREEN, 425 POST ROAD, FAIRFIELD, CT, 06824, US

(21) Appl. No.: 11/027,438

(22) Filed: Dec. 30, 2004

(51) Int. Cl. G09G 5/00

(52) U.S. Cl. 345/615

(57) ABSTRACT

A method for event countdown in a mobile communication apparatus is disclosed, including the steps of: selecting an event, an interval for the countdown, wherein the interval is a time before the event where the countdown starts, and a presentation of the countdown; and performing the presentation during the interval. Further, a mobile communication apparatus with an event countdown application is disclosed. The mobile communication apparatus performs a presentation in response to a time interval prior an event. Further, a computer program for performing the event countdown is disclosed.

### BACKGROUND OF THE INVENTION

1. Field of the Invention

The present invention relates to a method for event countdown in a mobile communication apparatus, a mobile communication apparatus comprising an event countdown application, and a computer program for event countdown.

2. Brief Description of Related Developments

Mobile communication apparatuses are many times involved in everyday life of their users, as they, besides providing ordinary telephone services, also comprise a plurality of applications to make the life of their users easier. Examples are calculator, game, calendar, and clock applications. However, more personal applications related to the user's life would further improve the help the mobile communication apparatus is able to provide its user.

### SUMMARY OF THE INVENTION

It is therefore an object of the present invention to provide an application related to a personal need of a user.

The above object is achieved according to a first aspect of the present invention by a method for event countdown for a mobile communication apparatus, comprising the steps of: selecting an event; selecting an interval for a countdown to the event, wherein the interval is a time before the event where the countdown starts; selecting a presentation of the countdown; and performing the presentation during the interval.

An advantage of this is that the user experiences a countdown to an important occurrence during an interval of time, where the countdown is presented to the user to emphasize that the occurrence is approaching.

The method may further comprise the step of selecting a time unit, wherein the interval is divided into a number of the time units.

This enables a selection of how the interval is divided, e.g. in days, hours, etc.

The presentation may illustrate the elapsed time units and the remaining time units of the interval. The presentation may comprise a new illustration for each of said time units. The illustration may be visual, and/or comprise audio.

Advantages of this is that it enables the illustration to be personal, such that the user gets the right feeling of the countdown.

The visual illustration may be a comb where each of the time units of the interval is represented by a tooth of the comb, and where one of the teeth is removed for each elapsed time unit.

Where the mobile communication apparatus comprises a user interface, which comprises a first and a second display, said illustration may be presented in said second display.

An advantage of this is improved freedom to view the countdown illustrations in one display, while the other display may view other things, or be obscured, as in a folded clamshell phone.

The presentation may be present when the mobile communication apparatus is in idle.

The method may further comprise the step of transmitting said event countdown to another communication entity, the event countdown comprising the selected event, interval, and presentation.

The method may further comprise the step of receiving the event countdown, the event countdown comprising an event, an interval, and a presentation, wherein selection of the event, interval, and presentation is performed from the received event countdown.

An advantage of this is to jointly look forward to an occurrence together with a mate, to whom the event countdown is sent, or from whom the event countdown is received.

The event countdown may be received from an application of a personal computer. The event may be selected from an application, e.g. a calendar, a to do list, a call reminder, and/or an alarmclock application, of said mobile communication apparatus.

Two or more event countdowns may be present at the same time, wherein the method further may comprise the step of assigning priorities to corresponding events, wherein said presentation is performed in accordance to said priorities. The presentation of the event with highest priority may then be performed, and the presentation of the other event may be presented with an icon.

The above object is achieved according to a second aspect of the present invention by a mobile communication apparatus, comprising a user interface, a processor, and an event countdown application arranged to cause said processor to select an event, select an interval for a countdown to said event, which interval is a time before said event where said countdown starts, select a presentation of the countdown, and perform said presentation during said interval through said user interface.

The interval may be divided into a number of time units. The presentation may illustrate the elapsed time units and the remaining time units of the interval. The presentation may comprise a new illustration for each of the time units. The illustration may be visual, and/or comprise audio. The user interface may comprise a first and a second display, and the illustration may then be viewed in the second display. The visual illustration may be a comb where each of the time units of the interval is represented by a tooth of said comb, and where one of the teeth is removed for each elapsed time unit.

The mobile communication apparatus may comprise a transmitter for sending the event countdown to another communication entity, the event countdown comprising the selected event, interval, and presentation. The mobile communication apparatus may comprise a receiver for receiving the event countdown, the event countdown comprising an event, an interval, and a presentation.

The event countdown may be received from an application of a personal computer.

The mobile communication apparatus may further comprise an application comprising events, wherein said event is selected from said events of said application, for example a calendar application comprising calendar events, wherein said event is selected from said calendar events, a to do list application comprising to do events, wherein said event is selected from of said to do events, a call reminder application comprising call reminder events, wherein said event is selected from said call reminder events, and/or an alarmclock application comprising alarm events, wherein said event is selected from said alarm events.

Two or more event countdowns may be present at the same time, the countdown application may then further comprise means for assigning priorities to events corresponding to said event countdowns, wherein said presentation is performed in accordance to said priorities. The presentation of the event with highest priority may then be performed, and the presentation of the other event may be presented with an icon while said presentation of said event with the highest priority is performed.

The presentation may be present when the mobile communication apparatus is in idle.

The above object is achieved according to a third aspect of the present invention by a computer program arranged to cause a computer to perform the steps of the first aspect of the invention, when downloaded to and executed on said computer.

The advantages of the second and third aspects of the invention are similar to those of the first aspect of the invention.

The term “event countdown” means an application where countdown is performed, e.g. by a timer, to an expected event. The term “event” means an occurrence, planned or expected to happen. The term “interval” means a time period before an event, which time period begins at a first time and ends at the time of the event. The term “presentation” means an output through a user interface of a mobile communication apparatus directed to a user. The term “illustration” means a part of a presentation at a certain instant. The term “visual” means that it is receivable by the eyes of a user, e.g. through a display or light emitting units of a mobile communication apparatus. The term “audio” means output receivable by the ears of a user, e.g. through a speaker, headset, or buzzer of a mobile communication apparatus. The term “transmit” means sending information through a communication channel, e.g. a radio channel via a telecommunication network, a short link radio, or infra-red communication. The term “receive” means achieving information through a communication channel, e.g. a radio channel via a telecommunication network, a short link radio, or infra-red communication. The term “idle” means a state where no particular activity is present, beyond being ready for activities to start.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a block diagram of a mobile communication apparatus according to one embodiment of the present invention;

FIG. 2a and 2b shows different views of a mobile communication apparatus according to one embodiment of the present invention;

FIG. 3 is a flow chart illustrating a method according to one embodiment of the present invention;

FIG. 4 is a flow chart illustrating a method according to one embodiment of the present invention;

FIG. 5 is a flow chart illustrating a method according to one embodiment of the present invention;

FIG. 6 is a flow chart illustrating a presentation according to one embodiment of the present invention; and

FIGS. 7a to 7c illustrates an example of presentation

according to one embodiment of the present invention.

### DETAILED DESCRIPTION OF PREFERRED EMBODIMENTS

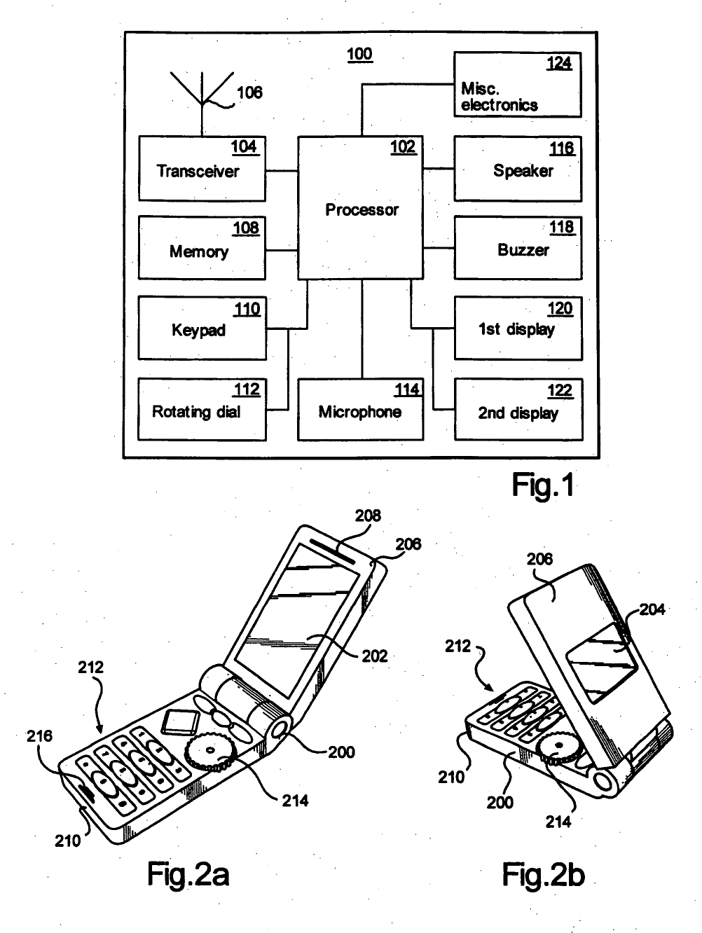

FIG. 1 is a block diagram schematically showing a mobile communication apparatus 100 according to an embodiment of the present invention. The mobile communication apparatus 100 comprises a processor 102 which is arranged to control functions of the mobile communication apparatus 100. The mobile communication apparatus 100 further comprises a transceiver 104 connected to the processor 102 which is arranged to receive and transmit radio signals through an antenna 106. The processor 102 can further be connected to a memory 108, a keypad 110, a rotating dial 112, a microphone 114, a speaker 116, a buzzer 118, a first display 120 and a second display 122. Further miscellaneous electronics 124, such as means for infrared data association (not shown) or a headset (not shown), can also be connected to the the processor. The memory 108 is connected to the processor 102 and is arranged to hold program code for applications and data used by the applications. The audio output comprise The buzzer 118, speaker 116, and headset (not shown) are parts of an audio output of the mobile communication apparatus 100. The audio output is associated with signal processing of the processor 102 for generating sounds. Similarly, the first and second displays 120, 122, or any other visual presentation such as light indicators (not shown) form a video output. Note that the video output can comprise a second display 122, as is common to have in mobile telephones of the type called clamshell, which will be further described in connection with FIGS. 2a and 2b, that is visible also when the telephone is folded up. For that reason, in the present invention, it can be an advantage to perform the presentation of the countdown in the second display 122, for some events.

FIG. 2a and 2b shows a mobile communication apparatus 200 according to an embodiment of the present invention, from different view angles, comprising a first display 202 and a second display 204 visible at opposite sides of a first body 206 of the mobile communication apparatus 200. Further, the mobile communication apparatus 200 is provided with a speaker 208 arranged in the first body 206. On a second body 210 of the mobile communication apparatus 200, keys 212, a rotating dial 214 and a microphone 216 are provided. A processor, memory, radio electronics and other electronics (not shown) are also provided in the second body 210. However, the keys 212, rotating input dial 214, speaker 208, microphone 216, processor, memory, radio electronics, and other electronics could be arranged in any other suitable way in the first or second bodies 206, 210 of the mobile communication apparatus 200.

The two bodies 206, 210 are foldable in relation to each other to form a so called clamshell structure. When the two bodies 206, 210 are folded up, the second display 204 is visible, and when the bodies 206, 210 are unfolded, also the first display 202 is visible.

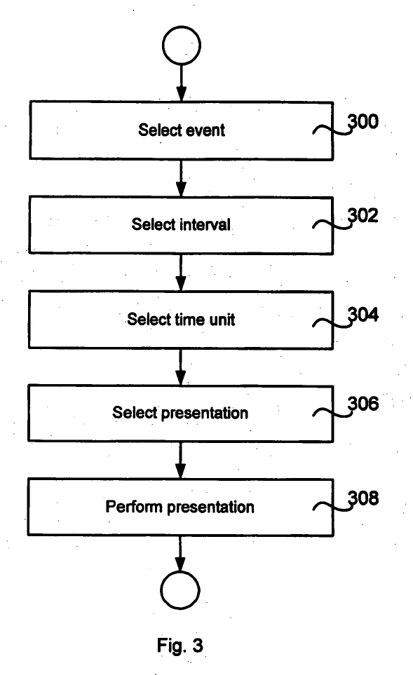

FIG. 3 is a flow chart illustrating a method for event countdown according to one embodiment of the present invention. An event is selected in an event selection step 300. The event may, for example, be selected from an application, e.g. a calendar, a to do list, a call reminder, and/or an alarmclock application. An interval is selected in an interval selection step 302, a time unit is selected in a time unit selection step 304, and a presentation is selected in a presentation selection step 306. These steps 300, 302, 304, 306 can be performed in any order. The selected presentation is performed according to the selected parameters in a presentation performance step 308.

The selected interval can start at the time of setting and end at the time of the event. Alternatively, the selected interval can start at a time determined by a user and end at the time of the event. The time units are chosen such that the presentation comprises a new illustration, i.e. is updated, for each time unit. The time unit can be determined by the user, or determined by a certain application calling the event countdown. For example, if the event countdown is an advent calendar, the time unit is one day, or if the event countdown is for the last lesson in math of the semester to end, the time period can be minutes.

The presentation can be different animations on a display of the mobile communication apparatus, presented in a part of the display, on a secondary display of the mobile communication apparatus, or on the entire display when the mobile communication apparatus is in an idle state. The case with presentation on the secondary display of the mobile communication apparatus is truly advantageous when the countdown is for a meeting the user is going to attend, and the user wants to quickly check how much time is left before the meeting starts, without e.g. unfolding a clamshell phone. The presentation can be selected from a library of presentations or downloaded from a network.

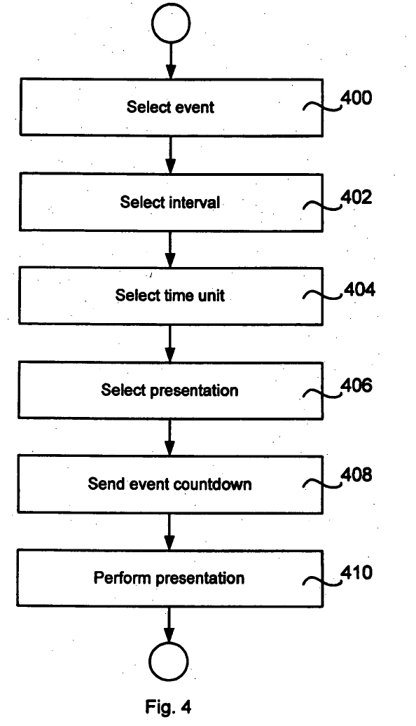

FIG. 4 is a flow chart illustrating a method for event countdown according to another embodiment of the present invention. An event is selected in an event selection step 400. The event may, for example, be selected from an application, e.g. a calendar, a to do list, a call reminder, and/or an alarmclock application. An interval is selected in an interval selection step 402, a time unit is selected in a time unit selection step 404, and a presentation is selected in a presentation selection step 406. These steps 400, 402, 404, 406 can be performed in any order. The event countdown parameters, i.e. the event, interval, time unit, and presentation, are sent to another communication entity in an event countdown sending step 408. The other communication entity can be another mobile communication apparatus and the transmission can be performed via a cellular network, a short link radio, an infra-red data association, or a wire. The user of the other communication entity is then able use the event countdown, if her communication apparatus is provided with an event countdown application. Alternatively, the countdown application can also be transmitted, where appropriate. The selected presentation is performed according to the selected parameters in a presentation performance step 410, in the sending mobile communication apparatus, and as will be described below, in the receiving mobile communication apparatus.

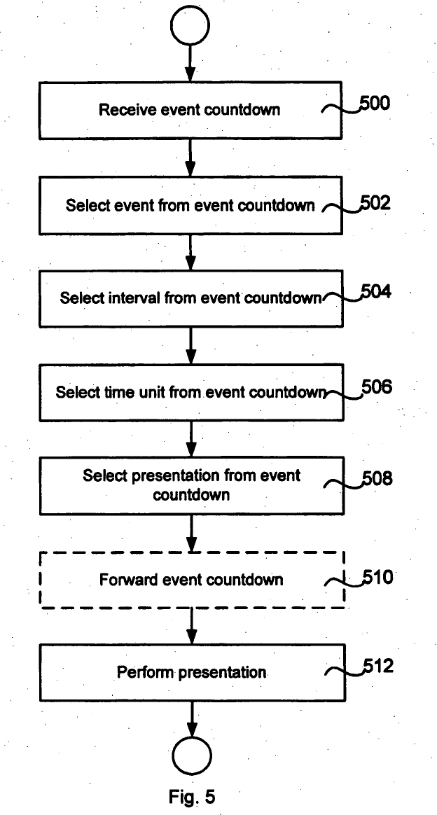

FIG. 5 is a flow chart illustrating a method for event countdown according to one embodiment of the present invention. An event countdown is received in an event countdown reception step 500. An event is selected from the received event countdown in an event selection step 502, an interval is selected from the received event countdown in an interval selection step 504, a time unit is selected from the received event countdown in a time unit selection step 506, and a presentation is selected from the received event countdown in a presentation selection step 508. Optionally, the received event countdown can be forwarded to further communication entities in an event countdown forwarding step 510. The event selection step 502, interval selection step 504, time unit selection step 506, presentation selection step 508, and event forwarding step 510 can be performed in any order. The presentation is performed in a presentation performance step 512.

A variation of any of the methods described is that two or more event countdowns may be present at the same time, wherein the methods further may comprise the step of assigning priorities to corresponding events, wherein the presentation is performed in accordance to said priorities. The presentation of the event with highest priority may then be performed, and the presentation of the other event may be presented with an icon.

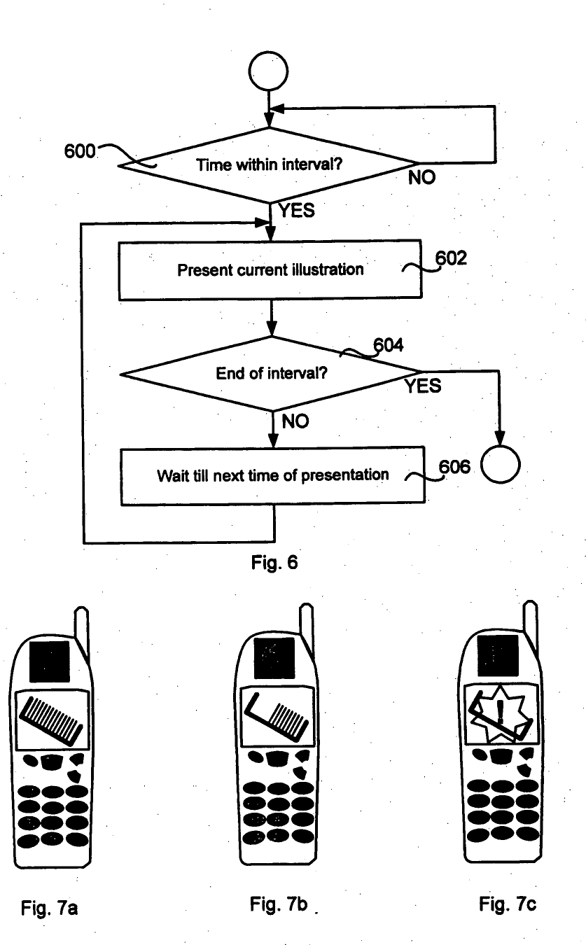

FIG. 6 is a flow chart illustrating an embodiment of the presentation step 308, 410, 512 in FIGS. 3, 4, 5, respectively. In a time interval checking step 600, it is checked if the current time is within the time interval of the event countdown. If not, i.e. the start of the interval is not reached, the time interval checking step 600 loops till it is time. When it is, a first illustration of the presentation will be presented in an illustration presentation step 602. Then, it is checked if the end of the interval is reached in an end-of-interval checking step 604. If the end of the interval is reached, the presentation ends. Otherwise, the presentation waits till next time of presentation, i.e. till next time unit, in a wait step 606, and then the method returns to the illustration presentation step 602, where the next illustration is presented.

The methods illustrated in FIGS. 3 to 6 are well suited to be implemented as computer programs.

FIGS. 7a to 7c illustrates an example of presentation

according to one embodiment of the present invention. In FIG. 7a, a first illustration is presented in a display of a mobile telephone, in this case a comb with a plurality of teeth representing the time units of the interval. For each elapsed time unit, a tooth of the comb is removed, i.e. a new illustration of a comb with fewer teeth is presented. As the new illustration is presented in the display, the illustration can also comprise a sound, e.g. the sound of a tooth being snatched off. The visual illustration can also be an animation showing the tooth being snatched off. FIG. 7b illustrates the comb where some of the teeth are removed, i.e. the elapsed time of the interval, and some teeth are still there, i.e. the remaining time of the interval. FIG. 7c illustrates the last illustration of the time interval, i.e. at the time of the event. The last illustration can also comprise additional visual and audio effects to emphasize the climax. The final illustration is preferably selectable in a particular selection step.

The presentation can be an Advent calendar showing different pictures for each day of Advent, a countdown for a rock concert showing different pictures of band members each day and playing different songs expected to be heard at the concert at a certain time of each day, discreet signs on the display before a secred date, or any other presentation that the user find suitable for an event she is waiting for.

1. A method for event countdown for a mobile: communication apparatus, comprising the steps of:
selecting an event;
selecting an interval for a countdown to said event, wherein said interval is a time before said event where said countdown starts;
selecting a presentation of the countdown; and
performing said presentation during said interval.

2. The method according to claim 1, further comprising the step of selecting a time unit, wherein said interval is divided into a number of said time units.

3. The method according to claim 2, wherein said presentation illustrates the elapsed time units and the remaining time units of said interval.

4. The method according to claim 2, wherein said presentation comprises a new illustration for each of said time units.

5. The method according to claim 4, wherein said illustration is visual.

6. The method according to claim 5, wherein said illustration further comprises audio.

7. The method according to claim 5, wherein said mobile communication apparatus comprises a user interface, which comprises a first and a second display, and said illustration is presented in said second display.

8. The method according to claim 1, wherein said presentation is present when said mobile communication apparatus is in idle.

9. The method according to claim 1, further comprising the step of transmitting said event countdown to another communication entity, said event countdown comprising said selected event, interval, and presentation.

10. The method according to claim 1, further comprising the step of receiving said event countdown, said event countdown comprising an event, an interval, and a presentation, wherein selection of said event, interval, and presentation is performed from said received event countdown.

11. The method according to claim 10, wherein said event countdown is received from an application of a personal computer.

12. The method according to claim 1, wherein said event is selected from a calendar application of said mobile communication apparatus.

13. The method according to claim 1, wherein two or more event countdowns are present at the same time, the method further comprising the step of assigning priorities to corresponding events, wherein said presentation is performed in accordance to said priorities.

14. The method according to claim 13, wherein the presentation of the event with highest priority is performed, and the presentation of the other event is presented with an icon.

15. The method according to claim 1, wherein said event is selected from a to do list application of said mobile communication apparatus.

16. The method according to claim 1, wherein said event is selected from a call reminder application of said mobile communication apparatus.

17. The method according to claim 1, wherein said event is selected from an alarmclock application of said mobile communication apparatus.

18. The method according to claim 1, wherein said event is selected from an application of said mobile communication apparatus.

19. A mobile communication apparatus, comprising
a user interface;
a processor; and
an event countdown application arranged to cause said processor to select an event, select an interval for a countdown to said event, which interval is a time before said event where said countdown starts, select a presentation of the countdown, and perform said presentation during said interval through said user interface.

20. The mobile communication apparatus according to claim 19, wherein said interval is divided into a number of time units.

21. The mobile communication apparatus according to claim 20, wherein said presentation illustrates the elapsed time units and the remaining time units of said interval.

22. The mobile communication apparatus according to claim 20, wherein said presentation comprises a new illustration for each of said time units.

23. The mobile communication apparatus according to claim 22, wherein said illustration is visual.

24. The mobile communication apparatus according to claim 23, wherein said user interface comprises a first and a second display, and said illustration is viewed in said second display.

25. The mobile communication apparatus according to claim 23, wherein said illustration further comprises audio.

26. The mobile communication apparatus according to claim 19, comprising a transmitter for sending said event countdown to another communication entity, said event countdown comprising said selected event, interval, and presentation.

27. The mobile communication apparatus according to claim 19, comprising a receiver for receiving said event countdown, said event countdown comprising said event, interval, and presentation.

28. The mobile communication apparatus according to claim 27, wherein said event countdown is received from an application of a personal computer.

29. The mobile communication apparatus according to claim 19, wherein said presentation is present when said mobile communication apparatus is in idle.

30. The mobile communication apparatus according to claim 19, further comprising a calendar application comprising calendar events, wherein said event is selected from said calendar events.

31. The mobile communication apparatus according to claim 19, wherein two or more event countdowns are present at the same time, the countdown application further comprising means for assigning priorities to events corresponding to said event countdowns, wherein said presentation is performed in accordance to said priorities.

32. The mobile communication apparatus according to claim 31, wherein the presentation of the event with highest priority is performed, and the presentation of the other event is presented with an icon while said presentation of said event with the highest priority is performed.

33. The mobile communication apparatus according to claim 19, further comprising a to do list application comprising to do events, wherein said event is selected from of said to do events.

34. The mobile communication apparatus according to claim 19, further comprises a call reminder application comprising call reminder events, wherein said event is selected from said call reminder events.

35. The mobile communication apparatus according to claim 19, further comprising an alarmclock application comprising alarm events, wherein said event is selected from said alarm events.

36. The mobile communication apparatus according to claim 19, further comprising an application comprising events, wherein said event is selected from said events of said application.

37. A computer program arranged to cause a computer to perform the steps of claim 1, when downloaded to and executed on said computer.
